(19) United States
(12) Patent Application Publication
(10) Pub. No.: US 2017/0142487 A1
(43) Pub. Date: May 18, 2017

(54) METHODS AND DEVICES FOR RECOMMENDING VIDEOS THROUGH BLUETOOTH TECHNOLOGY

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Qin HUANG, Tianjin (CN); Hailan YU, Tianjin (CN)

(21) Appl. No.: 15/235,073

(22) Filed: Aug. 11, 2016

Related U.S. Application Data
(63) Continuation of application No. PCT/CN2016/087339, filed on Jun. 27, 2016.

(30) Foreign Application Priority Data
Nov. 13, 2015 (CN) 201510780795.7

(51) Int. Cl. H04N 21/466; G06F 17/30; H04N 21/422; H04N 21/45; H04N 21/84; H04N 21/4415; H04L 29/06; H04N 21/4363

(52) U.S. Cl. CPC H04N 21/4668; H04L 63/0861; G06F 17/3097; H04N 21/43637; H04N 21/4532; H04N 21/84; H04N 21/4415; H04N 21/422

(57) ABSTRACT

An embodiment of the present disclosure provides a method for recommending videos through Bluetooth technology, a remote controller and a smart television. The method comprises: establishing a Bluetooth connection with the remote controller; receiving a new-user notification message transmitted by the remote controller through the Bluetooth connection; the new-user notification message comprises user information which is obtained after using the remote controller to identify fingerprint input by user and to perform identity authentication; recommending videos to users based on the user information. According to the present disclosure, the smart television is capable of receiving new-user notification message transmitted by the remote controller through Bluetooth connection and recommending videos to users base on the user information; Users' manual search and input are not needed any more; Users' manual operation frequency is reduced and smart service is provided for users.

### CROSS-REFERENCE TO RELATED APPLICATIONS

The present disclosure is a continuation of International Application No. PCT/CN2016/087339 filed on Jun. 27, 2016, which is based upon and claims priority to Chinese Patent Application No. 201510780795.7, entitled “METHOD FOR RECOMMENDING VIDEOS THROUGH BLUETOOTH TECHNOLOGY,” filed Nov. 13, 2015, and the entire contents of all of which are incorporated herein by reference.

### FIELD OF TECHNOLOGY

The present disclosure generally relates to the technical field of smart televisions and especially relates to methods and devices for recommending videos through Bluetooth technology.

### BACKGROUND

Smart televisions not only have a fully-open platform, but also carry an operating system. When enjoying the content of ordinary televisions, users can install and uninstall various kinds of application software by themselves and can continuously expand and upgrade the functions. The smart televisions are capable of continuously bringing about rich and personalized experience differing from that of the television sets used in digital cable television technology (Set Top Box).

Nowadays, smart televisions can access the Internet and cable televisions and can provide more videos for users to watch. When users watch videos, users manually operate the remote controller to choose the Internet or the cable television as a signal source and then manually operate the remote controller to choose what they want to watch; or the search function is adopted, with users manually inputting the names or abbreviations of the videos through the remote controller.

Therefore, a technical problem needed to be solved is how to reduce the frequency of users' manual operations.

### SUMMARY

The embodiment of the present disclosure provides a method for recommending videos through Bluetooth technology, a remote controller and a smart television; the present disclosure aims to solve the technical problems that users need to manually search videos and the manual operation times are relatively more in the prior art.

In one aspect of the present disclosure, the embodiment of the present disclosure discloses a method for recommending videos through Bluetooth technology; the method is applicable to the smart television matched with the remote controller and includes the steps of:

establishing a Bluetooth connection with the remote controller;

receiving a new-user notification message transmitted by the remote controller according to the Bluetooth connection; the new-user notification message includes user information which is obtained by using the remote controller to identify a fingerprint input by a user and to perform identity authentication;

recommending videos to users according to the user information.

In the other aspect of the present disclosure, the embodiment of the present disclosure discloses a method for recommending videos through Bluetooth technology; the method includes the steps of:

establishing a Bluetooth connection with a smart television;

identifying a fingerprint input by a user and performing identity authentication on the fingerprint;

if the identity authentication is approved, acquiring the corresponding user information of the fingerprint, in which the user information includes a user ID and a user name;

transmitting the new-user notification information, including the user information, to the smart television through the Bluetooth connection.

According to the other aspect of the present disclosure, the embodiment of the present disclosure discloses a smart television, including: a first processor; and a first memory for storing instructions executable by the processor, wherein the processor is configured to:

establish a Bluetooth connection with a remote controller;

receive a new-user notification message transmitted by the remote controller through the Bluetooth connection; the new-user notification message includes user information which is obtained by using the remote controller to identify a fingerprint input by a user and to perform identity authentication;

recommend videos to users according to the user information.

According to the other aspect of the present disclosure, the embodiment of the present disclosure discloses a remote controller, including: a second processor; and a second memory for storing instructions executable by the processor, wherein the processor is configured to:

establish a connection with a smart television;

identify a fingerprint input by a user and perform the identity authentication on the fingerprint; if the identity authentication is approved, acquire the corresponding user information of the fingerprint; the user information includes the user ID and the user name;

transmit the new-user notification message, including the user information, to the smart television through the Bluetooth connection.

According to another aspect of the present disclosure, a computer program is provided and includes computer readable codes; when the computer-readable codes are run on the smart television, the smart television is resulted in implementing the method.

According to another aspect of the present disclosure, a computer program is provided and includes computer readable codes; when the computer readable codes are run on the remote controller, the remote controller is resulted in implementing the method.

According to one more aspect of the present disclosure, a computer readable medium is provided and stores the computer program.

The beneficial effects of the present disclosure are as follows:

according to the method of recommending videos through Bluetooth technology, the remote controller and the smart television provided by the embodiment of the present disclosure, the smart television is capable of receiving the new-user notification message, transmitted by the remote controller, through the Bluetooth connection, and recommending the corresponding videos to users according to the user information; users' manual search is not needed anymore, users' manual operation frequency is reduced and smart service is provided for users.

The description is only the summary of the technical solution of the present disclosure; in order to understand the technical solutions of the present disclosure more clearly, the technical solutions can be implemented according to the content of the description; moreover, the above-mentioned purpose, and other purposes, features and advantages of the present disclosure can be more obvious and understandable, the following embodiments of the present disclosures are adopted.

### BRIEF DESCRIPTION OF THE DRAWINGS

In order to illustrate the embodiments of the present disclosure or the technical solutions in the prior art more clearly, the drawings to be used in the embodiments or the description of the prior art are introduced simply; obviously, the drawings in the following description are some embodiments of the present disclosure; ordinary technicians in this field can acquire other drawings according to the following drawings without creative work.

FIG. 1 is the step diagram of the method for recommending videos through Bluetooth technology, according to a first embodiment of the present disclosure.

FIG. 2 is the step diagram of the method for recommending videos through Bluetooth technology according to a second embodiment of the present disclosure.

FIG. 3 is the scene diagram of implementing a Bluetooth connection between the remote controller and the smart television, according to a second embodiment of the present disclosure.

FIG. 4 is the structural diagram of a smart television according to a third embodiment of the present disclosure.

FIG. 5 is the structural diagram of a remote controller according to a fourth embodiment of the present disclosure.

FIG. 6 schematically illustrates a block diagram of the electronic device used for implementing the method of the present disclosure.

FIG. 7 schematically illustrates a memory cell used for storing or carrying program codes used for realizing the method of the present disclosure.

### DESCRIPTION OF THE EMBODIMENTS

In order to make the purposes, technical solutions and advantages of the embodiment of the present disclosure more clear, the technical solutions in the embodiment of the invention are clearly and completely described in combination with the drawings in the embodiment of the invention; the described embodiments are not all the embodiments, but part of the embodiments of the present disclosure. Based on the embodiments of the present disclosure, other embodiments obtained by ordinary technicians without creative work belong to the protective scope of the present disclosure.

### First Embodiment

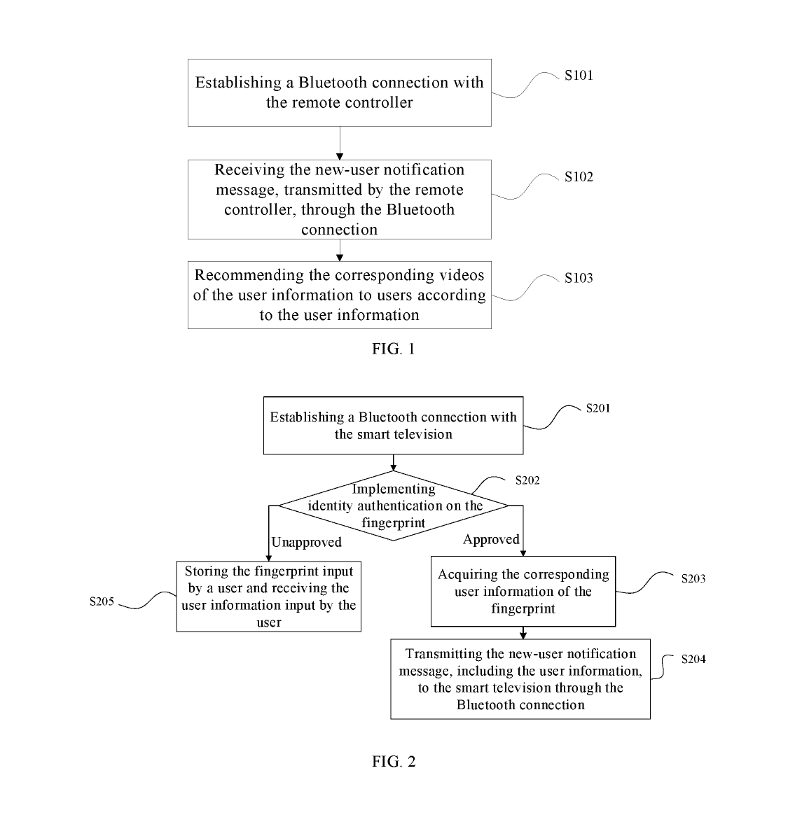

FIG. 1 shows the step diagram of the method of recommending videos, provided by the embodiment of the present disclosure, through Bluetooth technology.

The first embodiment of the present disclosure provides a method for recommending videos through Bluetooth technology and is shown in FIG. 1; the method is applicable to a smart television matched with the remote controller and includes the steps as follows.

Step S101, establishing a Bluetooth connection with the remote controller.

In this step, the smart television can establish a Bluetooth connection with the remote controller through the SDP (Service Discovery Protocol). The remote controller is the one matched with the smart television and has a user fingerprint acquisition function.

Step S102, receiving the new-user notification message, transmitted by the remote controller, through the Bluetooth connection.

In this step, the new-user notification message includes the user information; the user information is obtained by using the remote controller to identify a fingerprint input by a user and implement identity authentication. The smart television can receive the new-user notification message, transmitted by the remote controller, in the way of configuring the user information service characteristic descriptor and the recommendation service descriptor. The user information includes a user ID (Identification) and a user name and certainly can include other information.

Step S103, recommending the corresponding videos of the user information for users according to the user information.

In this step, the corresponding videos of the user information can be the videos which are recommended by analyzing users' watching behaviors and recommended to users according to the analysis results.

The embodiments of the present disclosure provide a method for preferably recommending videos to users; the corresponding watching history of the user information is acquired according to the user information and videos in the same type of the watching history are recommended to users. Of course, the latest push-delivery videos such as the latest movies can be recommended to users; highly-popular videos such as Nirvana in Fire can also be recommended; videos acted by the same actors and directed by the same director can also be recommended to users. The users' viewing frequency of the videos can be improved, users' manual search of the videos is not needed and users' manual operation frequency is reduced.

According to the method of recommending videos through the Bluetooth technology provided by the first embodiment of the present disclosure, the new-user notification message, transmitted by the remote controller, can be received through the Bluetooth connection; the corresponding videos can be recommended to users according to the user information; users' manual search is not needed any more, users' manual operation frequency is reduced and smart service is provided for users.

### Second Embodiment

FIG. 2 shows the step diagram of the method for recommending videos through Bluetooth technology, provided by the second embodiment of the present disclosure.

The second embodiment of the present disclosure provides a method for recommending videos through Bluetooth technology; the method can be implemented by the remote controller matched with the smart television shown in FIG. 2; the method includes the following steps:

Step S201, establishing a Bluetooth connection with the smart television.

In this step, the remote controller can be connected by Bluetooth to the smart television through the SDP.

Step S202, identifying a fingerprint input by a user and performing identity authentication on the fingerprint.

In this step, the identity authentication is identifying who the user inputting the fingerprint is and distinguishing the user and the other users of the smart television. The present disclosure provides a method for preferably performing identity authentication on the fingerprint; the method includes the steps of: identifying the fingerprint input by the user and contrasting the fingerprint with at least one pre-stored fingerprint; if the similarity between the fingerprint and any pre-stored fingerprint exceeds the threshold value, the corresponding user information of the pre-stored fingerprint is acquired. The pre-stored fingerprint can be the fingerprint input by the smart television user in advance. If the identity authentication is approved, executing the step S203; if not, executing the step S205.

Step S203, acquiring the corresponding user information of the fingerprint; the user information includes a user ID and a user name.

In this step, while storing the fingerprint, the user's smart remote controller stores the corresponding user information of the fingerprint.

Step S204, transmitting the new-user notification message, including the user information, to the smart television through the Bluetooth connection.

Step S205, storing the fingerprint input by the user and receiving the user information input by the user.

In this step, if the remote controller does not store the user's fingerprint and cannot identify the user's identity, the user is a new user without using the method of recommending videos through the Bluetooth technology; therefore, the remote controller can store the fingerprint input by the user and receive the user information input by the user, so that the remote controller can successfully implement identity authentication and obtain the corresponding videos recommended by the smart television when the user next inputs the fingerprint.

According to the method of recommending videos through the Bluetooth technology provided by the second embodiment of the present disclosure, the user's fingerprint and the corresponding information can be stored in the remote controller; when the user inputs the fingerprint, the remote controller can identify the user's identity according to the pre-stored fingerprint, transmit the new-user notification message, including the user information, to the smart television and acquire the relative videos recommended by the smart television; in this process, the user only needs to input the fingerprint and the user's manual operation frequency is reduced obviously.

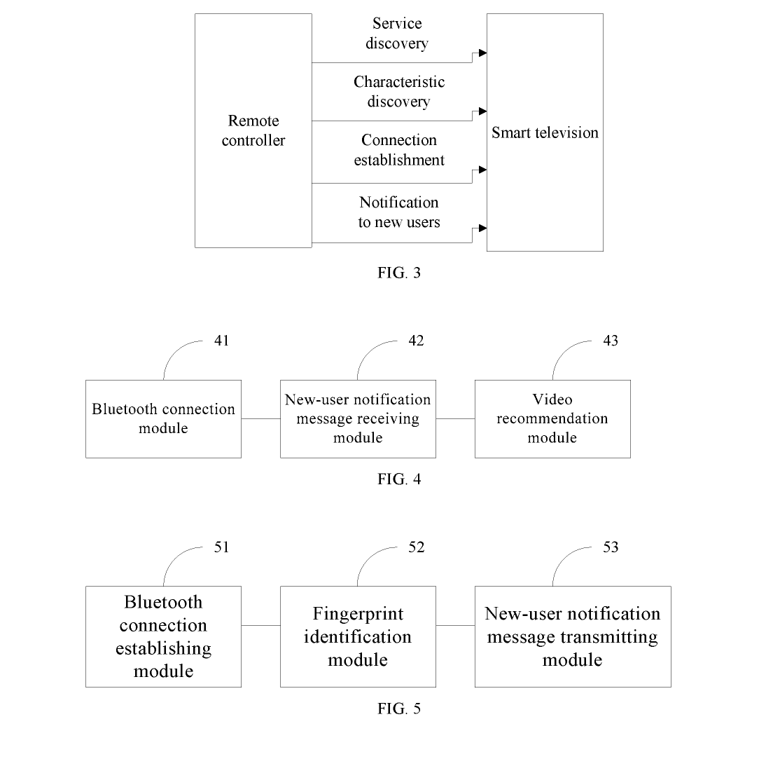

In the embodiments of the present disclosure, the remote controller establishes the Bluetooth connection with the smart television and transmits the new-user notification message to the smart television as shown in FIG. 3; in FIG. 3, the remote controller receives the UUID broadcast by the smart television; according to the UUID, the remote controller performs service discovery, discovers the user information service and the recommendation service and discovers the user information service characteristic descriptor and the recommendation service descriptor through the characteristic discovery; the user information service characteristic descriptor and the recommendation service descriptor are configured to the user information, so that the Bluetooth connection is established; after the establishment of the Bluetooth connection, the remote controller can transmit the new-user notification message to the smart television.

### Third Embodiment

FIG. 4 is the structural diagram of a smart television provided by the third embodiment of the present disclosure.

The third embodiment of the present disclosure provides a smart television; the smart television is capable of implementing the method of recommending videos through the Bluetooth technology and is shown in FIG. 4; the smart television includes a Bluetooth connection module 41, a new-user notification message receiving module 42 and a video recommendation module 43.

In the third embodiment of the present disclosure, the Bluetooth connection module 41 is used for establishing a Bluetooth connection with the remote controller; the new-user notification message receiving module 42 is used for receiving the new-user notification message transmitted by the remote controller through the Bluetooth connection; the new-user notification message includes the user information which is obtained by using the remote controller to identify the finger input by the user and to implement the identity authentication; the video recommendation module 43 is used for recommending the corresponding videos of the user information to users according to the user information.

In the Bluetooth connection module 41, the smart television can establish the Bluetooth connection with the remote controller through the SDP. The remote controller is the one matched with the smart television and has a user's fingerprint acquisition function.

In the new-user notification message receiving module 42, the new-user notification message includes the user information which is obtained by using the remote controller to identify the finger input by the user and to implement the identity authentication. The smart television can receive the new-user notification message, transmitted by the remote controller, in the way of configuring the user information service characteristic descriptor and the recommendation service descriptor. The user information includes the user ID and the user name and can include other information.

In the video recommendation module 43, the corresponding videos of the user information can be the videos which are recommended by analyzing users' watching behaviors and recommended to users according to the analysis results. Preferably, the video recommendation module 43 acquires the corresponding watching history of the user information according to the user information and recommends the videos that match the watching history of the users. Of course, the latest push-delivery videos such as the latest movies can be recommended to users; high-popularity videos such as Nirvana in Fire can also be recommended; videos featuring the same actors and directed by the same director can also be recommended to users. The users' watching frequency of the videos can be improved, users' manual search of the videos is not needed and users' manual operation frequency is reduced.

According to the smart television provided by the third embodiment of the present disclosure, the new-user notification message, transmitted by the remote controller, can be received through the Bluetooth connection; the corresponding videos can be recommended to users according to the user information; users' manual search is not needed any more, users' manual operation frequency is reduced and smart service is provided for users.

### Fourth Embodiment

FIG. 5 is the structural diagram of a remote controller provided by the fourth embodiment of the present disclosure.

The fourth embodiment of the present disclosure provides a remote controller; the remote controller can implement the method of recommending videos through the Bluetooth technology provided by the second embodiment of the present disclosure; the remote controller is shown in FIG. 5 and includes a Bluetooth connection establishing module 51, a fingerprint identification module 52 and a new-user notification message transmitting module 53.

In the fourth embodiment of the present disclosure, the Bluetooth connection establishing module 51 is used for establishing a Bluetooth connection with a smart television; the fingerprint identification module 52 is used for identifying a fingerprint input by a user and performing the identity authentication on the fingerprint; if the identity authentication is approved, the corresponding user information of the fingerprint is acquired; the user information includes the user ID and the user name; the new-user notification message transmitting module 53 is used for transmitting the new-user notification message, including user information, to the smart television through the Bluetooth connection.

The Bluetooth connection establishing module 51 includes the following modules: a UUID receiving unit is used for receiving the UUID broadcast by the smart television; a service discovery unit is used for discovering the user information service and the recommendation service according to the UUID and discovering the user information service characteristic descriptor and the recommendation service descriptor through the characteristic discovery; a descriptor configuration unit is used for configuring the user information service characteristic descriptor and the recommendation service descriptor on the user's information. Therefore, the Bluetooth connection establishing module 51 establishes a Bluetooth connection with the smart television.

In the fingerprint identification module 52, the identity authentication is identifying who the user inputting the fingerprint is, and distinguishing the user and the other users of the smart television. The present disclosure provides a method for preferably performing identity authentication on the fingerprint; the method includes the steps of: identifying the fingerprint input by the user and contrasting the fingerprint with at least one pre-stored fingerprint; if the similarity between the fingerprint and any pre-stored fingerprint exceeds the threshold value, acquiring the corresponding user information of the pre-stored fingerprint. The pre-stored fingerprint can be the fingerprint input by the smart television user in advance.

According to a remote controller provided by the fourth embodiment of the present disclosure, the remote controller can store the user's fingerprint and the corresponding information of the fingerprint; when a user inputs a fingerprint, the remote controller can identify the user's identity according to the pre-stored fingerprint and transmit the new-user notification message, including the user information, to the smart television so as to acquire the relative videos recommended by the smart television; in this process, the user only needs to input the fingerprint and the user's manual operation frequency is obviously reduced.

The described device embodiments are only schematic; units described as separating parts can be or cannot be physically separated; unit displaying parts can be or cannot be physical units, that is, can be located at the same position or distributed on a plurality of network units. According to actual demands, the purposes of the solutions in the present embodiments are realized by choosing all or some modules. Ordinary technicians in the field can understand and implement the embodiment without creative work.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

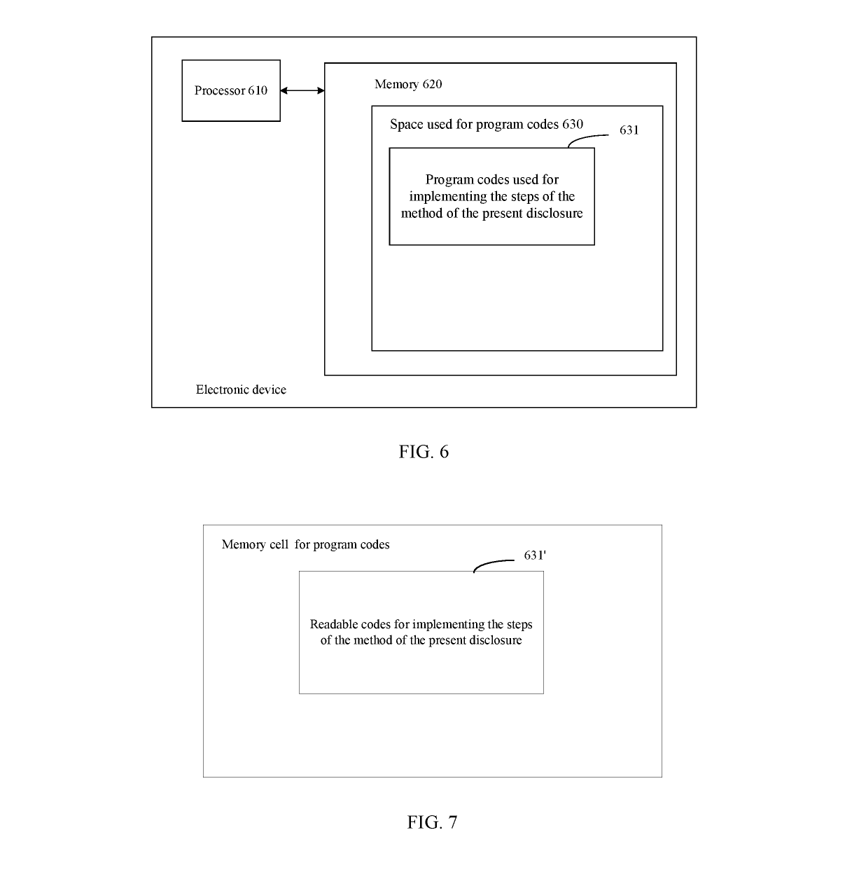

For example, FIG. 6 illustrates a block diagram of an electronic device for executing the method according the disclosure, such as the intelligent terminal or remote controller above. Traditionally, the electronic device includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed for example in an appropriate form. Usually, the memory cell includes computer readable codes 631′ which can be read for example by processors 610. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware including a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it is illustrated that the above embodiments are only used for describing the technical solutions of the present disclosure and are not affirmed to restrict the technical solutions; the present disclosure is described in detail according to the above-mentioned embodiments, thus the ordinary technicians in the field shall understand that technical solutions recorded in each embodiment can still be amended or some technical characteristics thereof can be substituted equally; these amendments or substitutions do not make the essence of the corresponding technical solution deviate from the spirit and scope of the technical solutions in each embodiment of the present disclosure.

What is claimed is:

1. A method for recommending videos through Bluetooth technology adapted to a smart television matched with a remote controller; the method comprising:
establishing Bluetooth connection with the remote controller;
receiving a new-user notification message transmitted by the remote controller through the Bluetooth connection; the new-user notification message comprises user information which is obtained after using the remote controller to identify a fingerprint input by a user and to perform identity authentication;
recommending videos to users based on the user information.

2. The method according to claim 1, wherein the user information comprises user ID and user name.

3. The method according to claim 1, further comprising:
acquiring watching history record of the user information and recommending same type videos based on the record.

4. The method according to claim 1, further comprising:
configuring user information service characteristic descriptor and recommendation service descriptor, and receiving the new-user notification message transmitted by the remote controller.

5. A method for recommending videos through Bluetooth technology, comprising:
establishing Bluetooth connection with a smart television;
identifying fingerprint input by user and performing identity authentication on the fingerprint;
if the identity authentication is approved, acquiring the corresponding user information of the fingerprint, in which the user information comprises user ID and user name;
transmitting new-user notification information which includes the user information to the smart television through the Bluetooth connection.

6. The method according to claim 5, further comprising:
identifying the fingerprint input by the user and contrasting the fingerprint with at least one pre-stored fingerprint;
if similarity between the fingerprint and any pre-stored fingerprint exceeds a threshold, acquiring the corresponding user information of the pre-stored fingerprint.

7. The method according to claim 5, further comprising:
receiving a UUID broadcasted by the smart television;
discovering a user information service and a recommendation service according to the UUID, and discovering user information service characteristic descriptor and recommendation service descriptor through characteristic discovery;
configuring the user information service characteristic descriptor and the recommendation service descriptor on the user information.

8. A smart television comprising:
a first processor; and
a first memory for storing instructions executable by the processor,
wherein the processor is configured to:
establish Bluetooth connection with a remote controller;
receive new-user notification message transmitted by the remote controller through the Bluetooth connection; the new-user notification message comprises user information which is obtained after using the remote controller to identify fingerprint input by user and to perform identity authentication;
recommend videos to users based on the user information.

9. The smart television according to claim 8, wherein the user information comprises user ID and user name.

10. The smart television according to claim 8, wherein the processor is further configured to acquire the corresponding watching history of the user information according to the user information and recommend same type videos based on the record.

11. The smart television according to claim 8, wherein the processor is further configured to configure a user information service characteristic descriptor and a recommendation service descriptor and receive the new-user notification message transmitted by the remote controller.

12. A remote controller comprising:
a second processor; and
a second memory for storing instructions executable by the processor,
wherein the processor is configured to:
establish Bluetooth connection with a smart television;
identify fingerprint input by user and perform identity authentication on the fingerprint; if the identity authentication is approved, acquire the corresponding user information of the fingerprint, in which the user information comprises a user ID and a user name;
transmit a new-user notification message which including the user information to the smart television through the Bluetooth connection.

13. The remote controller according to claim 12, wherein the processor is further configured to: identify the fingerprint input by the user and contrast the fingerprint with at least one pre-stored fingerprint; if a similarity between the fingerprint and any pre-stored fingerprint exceeds threshold, acquire the corresponding user information of the pre-stored fingerprint.

14. The remote controller according to claim 12, wherein the processor is further configured to:
receive a UUID broadcast by the smart television;
discover user information service and recommendation service according to the UUID, and discover user information service characteristic descriptor and recommendation service descriptor through the characteristic discovery;
configure the user information service characteristic descriptor and the recommendation service descriptor on the user information.
